(19) United States
(12) Patent Application Publication
(10) Pub. No.: US 2013/0269274 A1
(43) Pub. Date: Oct. 17, 2013

(54) METHOD AND SYSTEM FOR INSULATING PIPING IN AN EXTERIOR WALL

(71) Applicant: John Certuse, JR., Attleboro, MA (US)

(72) Inventor: John Certuse, JR., Attleboro, MA (US)

(21) Appl. No.: 13/905,509

(22) Filed: May 30, 2013

Related U.S. Application Data
(63) Continuation-in-part of application No. 12/246,588, filed on Oct. 7, 2008, now Pat. No. 8,146,311.
Application No. 12/246,588 is a continuation-in-part of application No. 13/332,884, filed on Dec. 21, 2011.

(51) Int. Cl. F16L 5/00

(52) U.S. Cl. CPC F16L 5/00
USPC 52/407.3

(57) ABSTRACT

A system for effectively insulating piping in a manner that protects the piping from freezing is disclosed. The insulation block is dimensioned particularly for installation into a building wall cavity. The insulation block has an interior side and an exterior side and a slot formed therein for receiving a pipe to be insulated. More particularly, the thickness of the insulation block is configured to match the dimensions of standard framing members wherein the slot for receiving the piping insures that the piping is positioned immediately adjacent the back surface of the interior sheathing material. The insulation block reliably provides a thickness of insulation material behind the piping. The insulation maintains the piping in thermal contact with the rear surface of the interior wall sheathing to facilitate heat transfer and provides an anti-condensation layer for cold water piping.

### CROSS-REFERENCE TO RELATED APPLICATIONS

This application is a continuation-in-part and claims priority from earlier filed U.S. Utility patent application Ser. No. 12/246,588, filed Oct. 7, 2008 and U.S. Utility patent application Ser. No. 13/332,884, Filed Dec. 21, 2011.

### BACKGROUND OF THE INVENTION

The present invention relates generally to a method and system for insulating piping. More specifically, the present invention relates to a method and system for effectively insulating piping located in an exterior wall construction in a manner that protects the piping from freezing.

In the construction of residential and commercial structures a variety of piping systems are installed to allow delivery of water to various plumbing fixtures such as sinks and toilets. Further, hydronic piping is installed to circulate a fluid medium, which is some cases is simply water, to effect heat transfer in order to heat the space. Often, due to the design of the space or the location of the various fixtures and heating elements, such piping must be located adjacent or within the cavity of the exterior walls of the structure. The difficulty created in these instances is that during the winter the temperature outside the wall construction and often within the wall cavity itself fall below 32° F., the freezing point of the water contained within these piping systems. When examined closely, the heat profile of a typical wall construction can be seen to have temperatures approaching the interior ambient temperature at the inner surface of the drywall within the wall bay and temperatures approaching exterior cold temperatures at the inner surface of the exterior sheathing within the same wall bay. Turning to FIG. 1, A typical wall construction can be seen having a wall cavity 2 filled with R-19 insulation 4 sandwiched between drywall 6 on the interior surface and plywood 8 and shingles 10 on the exterior surface. Given an interior ambient temperature of 70° F. and an exterior condition of 5° F. with a 15 MPH wind the temperature of profile within the wall cavity 2 can be seen to reach as low as 9.93° F. at the interior surface of the exterior sheathing 8. While theoretically the piping can be protected from freezing provided that it is positioned on the interior half of the wall where temperature can be seen to be above 38° F., actual practice does not always meet the theoretical design requirements as will be discussed below.

Since it is well recognized that the space in the wall cavity of an exterior wall can often reach freezing temperatures, the International Plumbing Code and most state plumbing codes provide a basic requirement that domestic water pipes installed in outside walls shall be protected from freezing either by heat, insulation or both. One issue with such code provisions, however, is that fact that the code does not provide any specific direction as to how such protection against freezing should be provided. Further, while these code provisions apply to domestic water supplies, the difficulty arises in that the parallel code relating to heating systems has not provided any requirements regarding the protection of hydronic piping from freezing. This situation is further aggravated because the lack of direction a code level has translated directly into a lack of industry support for the installation of insulation on hydronic piping in exterior walls. As a result, there have been a large number of pipe failures directly tied to the freezing of the piping installed in exterior walls, wherein the pipe failure has caused extensive building damage.

Turning to FIG. 2, generally, in the prior art, installers simply provide for the installation of their piping 12 into the wall cavity prior to the installation 4 of the building envelope. The installers then rely on the installer of the building insulation 4 to tuck the insulation material behind their piping 12 thereby theoretically positioning the piping 12 on the interior/warm side of the insulation 4 where it should be protected against freezing in most cases. While in theory such a practice should work, in most cases the actual installation does not comport with the theoretical ideal. For example, the installer of the insulation 4 may find it easier to install the insulation 4 over the top of the piping 12a leaving the piping 12 on the cold side of the insulation 4. Further, the installer may simply stop the insulation on either side of the piping 12b leaving a gap 14 that directly exposes the piping 12b to the cold side of the wall.

There are a number of different pipe insulation products that are currently available on the market today. Such insulation is generally configured as a pipe wrap in the form of jacketed fiberglass or a rubber material. These materials are installed fully around the exterior surface of the pipe thereby insulating the pipe. The problem that most people do not appreciated about the prior art insulation is that they are designed to prevent heat loss from the interior of the pipe to the exterior of the pipe. In other words they are intended to maintain the interior temperature of the fluid within the pipe. These insulation materials are not designed to address piping installed in locations prone to freezing.

There is therefore a need for a method and system for insulating piping that is specifically configured and designed for applications in exterior walls where the pipes are prone to freezing. There is a further need for a method and system of insulating piping in an exterior wall that reliably insures that the piping is protected from freezing by insuring that the piping is maintained as near to the ambient temperature of the interior of the structure as possible.

### BRIEF SUMMARY OF THE INVENTION

In this regard, the present invention provides a method and system for insulating piping installed in an exterior wall. More specifically, the present invention provides a method and system for effectively insulating piping located in an exterior wall construction in a manner that protects the piping from freezing. The system of the present invention provides for an insulation block that is dimensioned particularly for installation into a building wall cavity. The insulation block has an interior side and an exterior side and a slot formed therein for receiving a pipe to be insulated. More particularly, the thickness of the insulation block is configured to match the dimensions of standard framing members wherein the slot for receiving the piping insures that the piping is positioned immediately adjacent the back surface of the interior sheathing material. In this manner, the insulation system of the present invention protects the piping in two ways. First, the insulation block reliably provides a thickness of insulation material behind the piping such that the insulation material is positioned between the piping and the exterior wall surface. Second, the insulation maintains the piping in contact with the rear surface of the interior wall sheathing to facilitate heat transfer from the interior of the building and into the piping.

In other embodiments of the present invention, the insulation block may include adhesive on a rear surface thereof such that the insulation block can be adhered to the interior surface of the exterior wall sheathing when installed. In another embodiment, the front surface of the insulation block and interior surface of the slot may include a metallic tape or other heat transfer medium to increase the overall heat transfer from the interior sheathing to the piping received within the slot. Finally, the slot may be configured to extend nearly entirely around the piping received therein leaving only a small exposed region of the piping to be in contact with the rear surface of the interior sheathing.

Accordingly, it is an object of the present invention to provide a method and system for insulating piping that is specifically configured and designed for applications in exterior walls where the pipes are prone to freezing. It is a further object of the present invention to provide a method and system of insulating piping in an exterior wall that reliably insures that the piping is protected from freezing by insuring that the piping is maintained as near to the ambient temperature of the interior of the structure as possible. It is still a further object of the present invention to provide a system for insulating piping that reliably positions a thickness of insulation material behind the piping such that the insulation material is positioned between the piping and the exterior wall surface while also maintaining the piping in contact with the rear surface of the interior wall sheathing to facilitate heat transfer from the interior of the building and into the piping.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is cross-sectional side view of prior art wall construction and the heat distribution therethrough;

FIG. 2 is a cross-sectional plan view of prior art wall construction including piping installed therein;

FIG. 3 is a front, perspective view of the insulation system of the present invention;

FIG. 4 is a cross-sectional view taken along line 4-4 of FIG. 3;

FIG. 4a is an enlarged cross-sectional view taken along line 4-4 of FIG. 3;

FIG. 5 is a cross-sectional view reflecting an alternate embodiment;

FIG. 6 is a perspective view of the insulation system of the present invention installed into a wall framing system;

FIG. 7 is a cross-sectional view depicting an alternate embodiment of the insulation system of the present invention;

FIG. 8 is a cross-sectional view depicting a second alternate embodiment of the insulation system of the present invention;

FIG. 9 is a cross-sectional view depicting a third alternate embodiment of the insulation system of the present invention;

FIG. 10 is a cross-sectional view depicting the third alternate embodiment of the insulation system of the present invention; and

FIG. 11 is a cross-sectional view depicting the third alternate embodiment of the insulation system of the present invention in connection with several pipe dimensions both insulated and non-insulated against condensation.

### DETAILED DESCRIPTION OF THE INVENTION

Now referring to the drawings, method and system for insulating piping installed in an exterior wall is generally shown and illustrated. As was stated above, the present invention generally provides an improved method and system for effectively insulating piping located in an exterior wall construction in a manner that protects the piping from freezing.

Turning to FIG. 3, it can be seem that in its most general form, the system of the present invention provides for an insulation block 20 that is dimensioned particularly for installation into a building wall cavity. The insulation block 20 is generally regular in cross-section and is longitudinal extending from a proximal end 22 to a distal end 24. The insulation block 20 includes a front surface 26, a rear surface 28 and two side surfaces 30, 32 that all extend along a length of the insulation block 20 between the proximal 22 and distal 24 ends. The insulation block 20 can be seen to include at least one cavity 34 formed therein. It is preferred that the cavity 34 be formed in the insulation block 20 proximate the front surface 26 and that the cavity 34 extend along the length of the block 20 from the proximal end 22 to the distal end 24. In addition to the cavity 34, a slot 36 can be seen extending between the front surface 26 of the insulation block 20 and the cavity 34 formed therein. In operation, the cavity 34 in the insulation block 20 is configured to receive a pipe 38 therein such that a portion of the pipe 36 is exposed adjacent the front surface 26 of the insulation block 20.

The width or diameter of the cavity 34 is preferably the same size as that of the piping 38 to be received therein while the slot 36 is preferably narrower in width than the width/diameter of the cavity 34. This allows the piping 38 to be wrapped nearly fully by the insulation block 20 while leaving a space for the piping 38 to contact the rear surface of the interior sheathing.

It should be appreciated by one skilled in the art that while the insulation block 20 of the present invention is shown to be rectangular, such a profile was chosen for expediency and efficient use of material and extrusion equipment, any other profile shape may also be used and still fall within the scope of the present disclosure. Similarly, as will be descried below, the cavity 34 extends nearly entirely around the outer surface of the pipe 38 received therein leaving only a small exposed region of the piping 38 to be in contact with the rear surface of the interior sheathing. However, the cavity 34 may be formed to be square or U-shaped and still fall within the scope of the present disclosure.

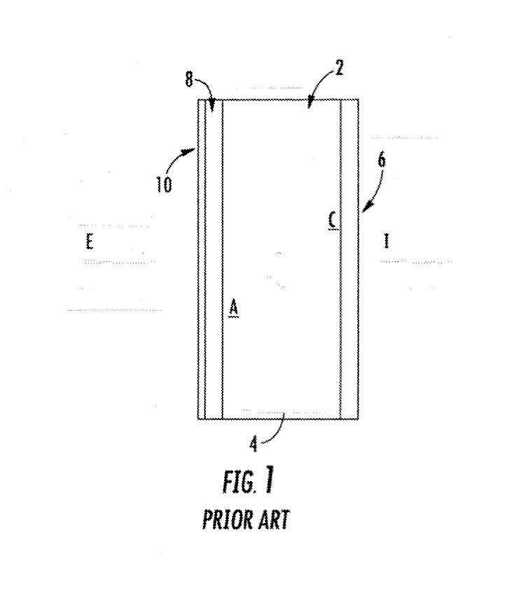

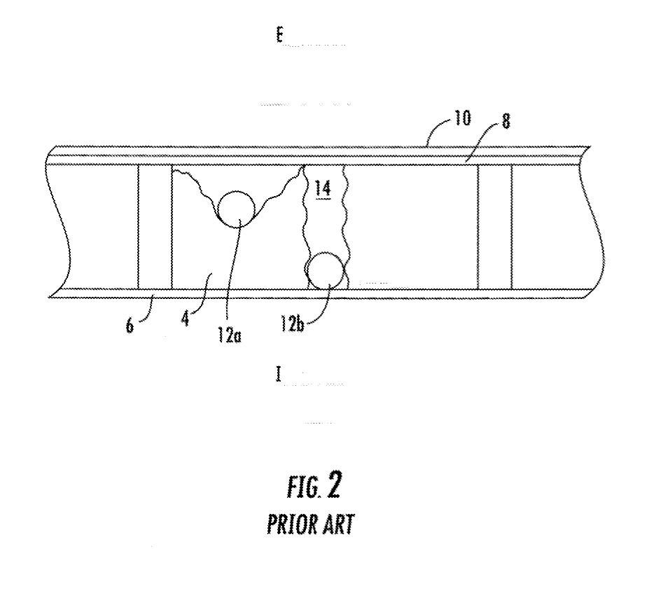

Turning now to FIG. 4 in conjunction with FIG. 3, the insulation block 20 of the present invention is configured for installation into an exterior wall structure having a cavity therein. As is well known in the art and as described above in FIGS. 1 and 2, such cavities 40 within exterior wall structures are formed as the space between exterior sheathing 42 and interior sheathing 44 and as such the cavity 40 has a warm side and a cold side. In operation, the insulation block 20 of the present invention is installed into the cavity 40 such that the rear surface 28 of the insulation block 20 is received adjacent the cold side of the cavity and the front surface 26 is received the warm side. As a result, it can also be seen that the pipe 38 received within the insulation block 20 is necessarily positioned adjacent the warm side of the cavity 40 as well. In this manner, the insulation block 20 provides an insulation system that positions the pipe 38 installed in the exterior wall in a predictable position that approximates the same plane as that plane against which the buildings interior sheathing 44 will be secured.

As can be appreciated, the operative principal of the present invention is to facilitate heat transfer from the interior of the building and into the piping 38 to prevent freezing thereof. To enhance the overall ability of the insulation system to transfer heat into the piping 38 contained within the cavity 34, the insulation block 20 may also include a continuous thermally conductive layer 46 that covers the interior surface of the cavity 34, the slot 36 and at least a portion of the front surface 26 of the insulation block 20 proximate the slot 36. Similarly, the thermally conductive layer 46 may extend fully over the front surface 26 of the insulation block 20, although preferably, the thermally conductive surface 46 will end approximately ½ inch from the edge of the front face 26 of the insulation block 20 to prevent cold from being conducted into the pipe 38 at the edge of the contact surface. Preferably, the thermally conductive layer 46 is a metallic layer such as a metallic tape. It is still more preferable that the thermally conductive layer 46 includes an adhesive layer thereon. By providing an adhesive layer on the thermally conductive layer 46, the present invention insures a firm contact between the outer surface of the pipe 38 and the thermally conductive layer 46 in order to increase the heat transfer flow into the pipe 38. In this manner, the present invention employs a directional insulation technique wherein heat is selectively projected or converged into a desired area while heat loss is effectively prevented. In this manner the focused heat improves both the heat transfer efficiency (in hydronic piping) and to make use of heated sources such as an interior wall adjacent a heated space to protect a pipe from freezing in a susceptible area. As a result, the directional insulation concept makes maximum use of the buildings interior heat by diverting this heat source into the piping allowing the piping to be heated without the use of an external (i.e. electrical resistance heating) heat source.

In addition to providing adhesive on the thermally conductive layer 46, it can be appreciated that the insulation block 20 may include adhesive on a rear surface 28 thereof such that the insulation block 20 can be adhered to the interior surface of the exterior wall sheathing 42 when the insulation block 20 is installed. Similarly, the front surface 26 may include an adhesive layer that adheres to the rear surface of the interior wall sheathing 44 as it is installed.

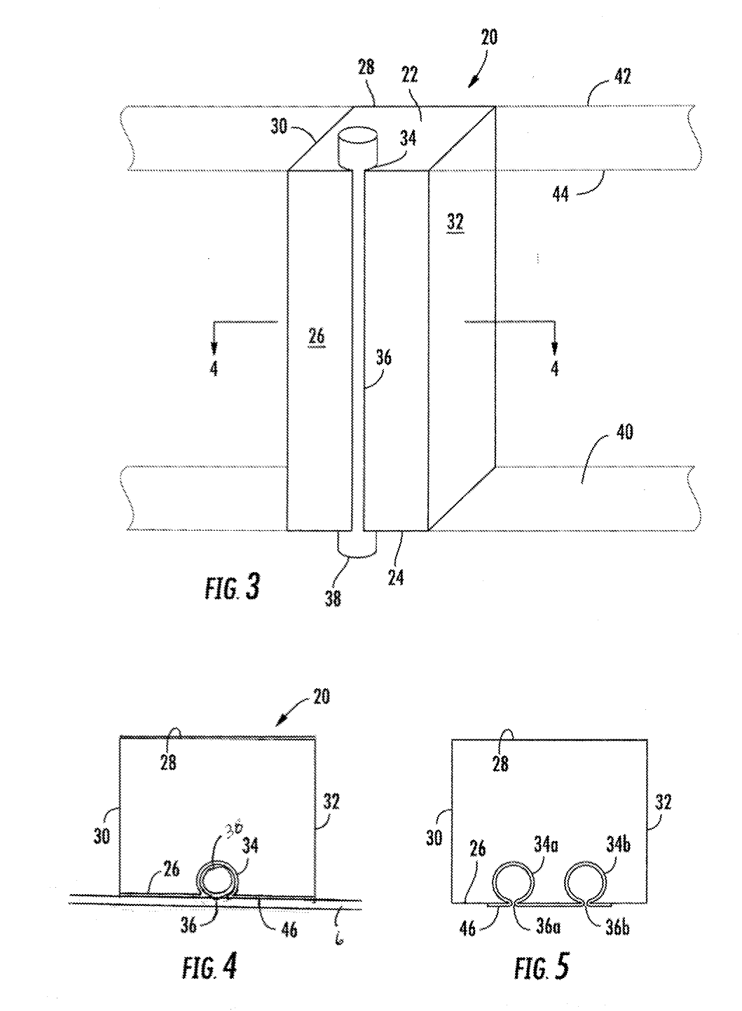

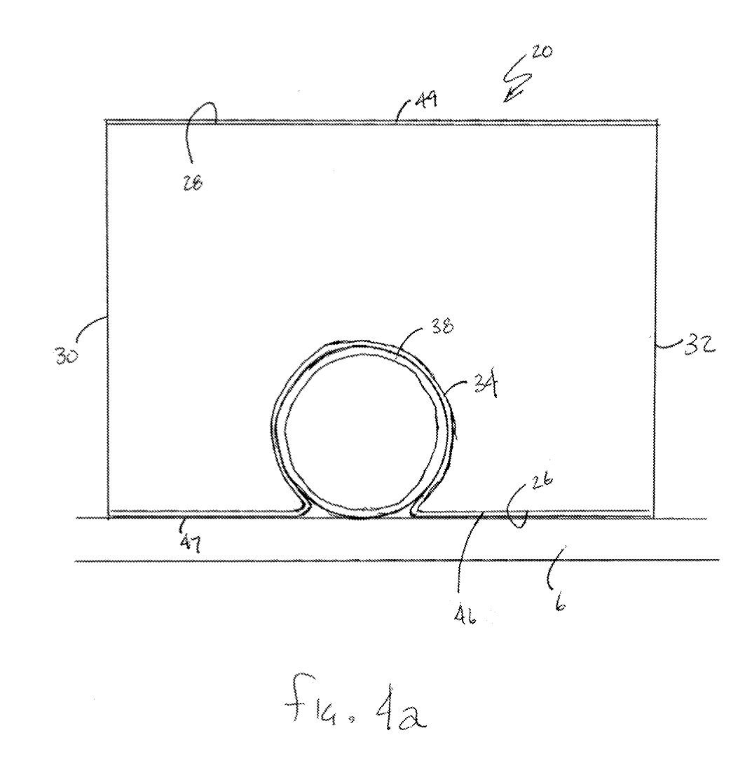

While the previous figures show a single cavity 34 and slot 36 formed in the insulation block 20, it can be seen in FIG. 5 that the teachings of the present invention are expandable to include a plurality of cavities 34a, 34b and slots 36a, 36b to accommodate multiple water supply pipes or a hydronic supply and return line for example. In this regard, two slots 36a, 36b adjoining two cavities 34a, 34b within the insulation block 20 are shown. Further, the teachings are scalable to any plurality of slots and cavities.

The construction of the insulation block 20 in the preferred embodiment consists of an extruded square block of Polystyrene with an R-value of between 5 and 6.5 per inch with outside dimensions that are slightly wider than the wall construction into which the insulation block 20 will be installed although any type of material known in the art would be equally applicable and fall within the scope of the present invention. In this manner, the width of the block 20 will be on the order of 1/16^{th} to ⅛^{th} of an inch larger than the width of the framing member used in constructing the wall cavity 40, allowing the insulation block 20 to be compressed as the interior sheathing 44 is installed thereby maintaining the piping in firm contact with the rear surface of the interior sheathing 44. In this manner the insulation block 20 is in compression between the interior sheathing 44 and the exterior sheathing 42 and is adhered thereto by the layers of adhesive to improve the installation process, increase the conductive heat transfer and eliminate the possibility of cold air infiltration reaching the piping. Should the insulation block 20 need to installed into a wall cavity 40 where the piping 38 is already installed and unmovable, the block 20 may be formed in two pieces as required to facilitate installation. For example, the block 20 may be formed as a front and back half wherein the front piece is installed around the piping 38 and the back half is then slid in behind. The compression of the block 20 within the wall cavity 40 negates any possibility of insulation inconsistency.

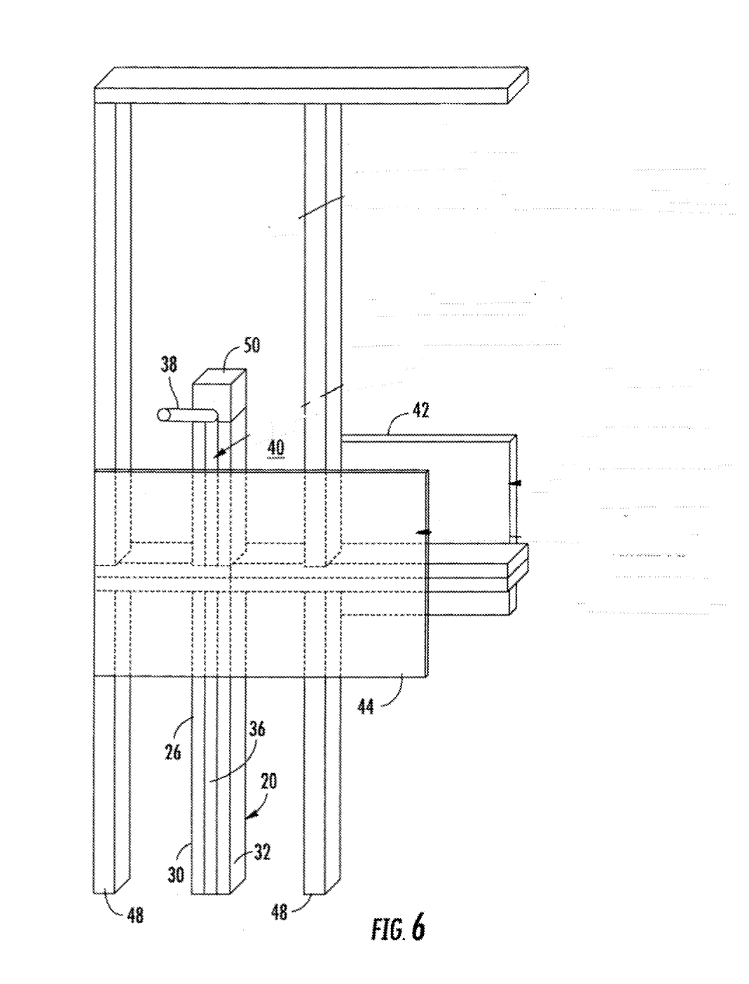

FIG. 6 depicts the insulation block 20 of the present invention in an installed location in relation to an exterior wall structure. The exterior wall structure is formed to include a plurality of spaced apart framing members 48 wherein the framing members 48 support exterior sheathing 42 on one side and interior sheathing 44 on an opposing side thereof. The framing members 48, interior sheathing 44 and exterior sheathing 42 all cooperate to form a cavity 40 therebetween such that the cavity 40 has a warm side adjacent the interior sheathing 44 and a cold side adjacent the exterior sheathing 42. The insulation block 20 is received within the cavity 40 with the rear surface 28 adjacent the exterior sheathing 42 and the front surface 26 adjacent the interior sheathing 44 such that the slot 36 with said piping 38 therein is at least partially open to the rear surface of the interior sheathing 44.

As stated above, the insulation block 20 has a width that is slightly greater than the width of the framing members 48 into which it is installed. In 2×4 construction for example where the framing members 48 are 3½″ wide, the insulation block 20 will have a width that is on the order of about 3 9/16″ to about 3⅝″. Similarly, in 2×6, where the framing members 48 are 5½″ the insulation block 20 will have a width that is on the order of about 5 9/16″ to about 5⅝″. In this manner, the thickness of the insulation block 20 is configured to match the dimensions of standard framing members 48 wherein the slot 36 for receiving the piping 38 insures that the piping 38 is positioned immediately adjacent the back surface of the interior sheathing 44 material. As a result, the insulation system of the present invention protects the piping 38 in two ways. First, the insulation block 20 reliably provides a thickness of insulation material behind the piping 38 such that the insulation material is positioned between the piping and the exterior wall surface. Second, the insulation maintains the piping 38 in contact with the rear surface of the interior wall sheathing 44 to facilitate heat transfer from the interior of the building and into the piping 38.

As stated above, the rear surface 28 of the insulation block 20 includes a tape covered adhesive surface allowing the block 20 to be stuck to the inner surface of the wall's outer sheathing 42 allowing stabilization and securing of the insulation block 20 during the construction phase of the building. As can be further seen in FIG. 5, intersection blocks 50 will be provided to allow the insulation system to be continuous from where it enters the wall to where it exits the wall through a 90 degree turn preventing any portion of the piping 38 from being out of this insulated system. As is standard in the industry, typical fiberglass R-13 insulation will be applied to the remaining spaces within the wall cavity 40.

To facilitate installation of the insulation blocks of the present invention, a template tool may be provided in order to locate the proper location in the wall for the drilling of penetration holes and the installation of the piping. In this manner, a template showing the location of the hole to be drilled in the sill (2×4 or 2×6) members of the wall will facilitate correct installation of the piping to allow later installation of the insulation block.

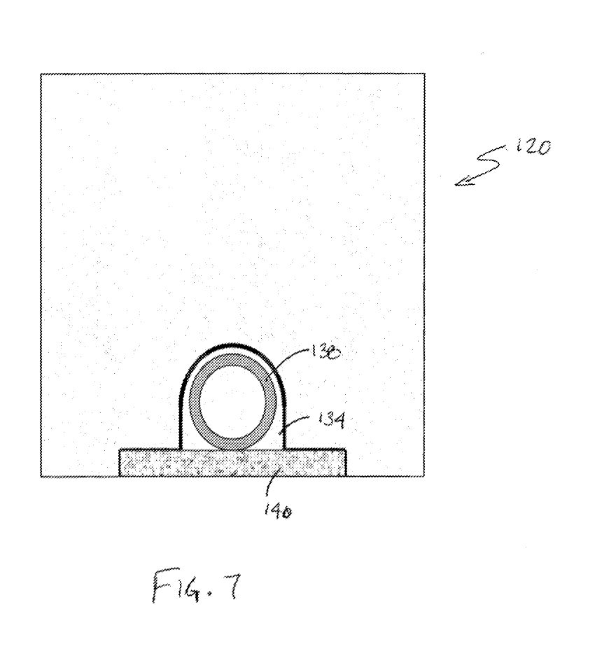

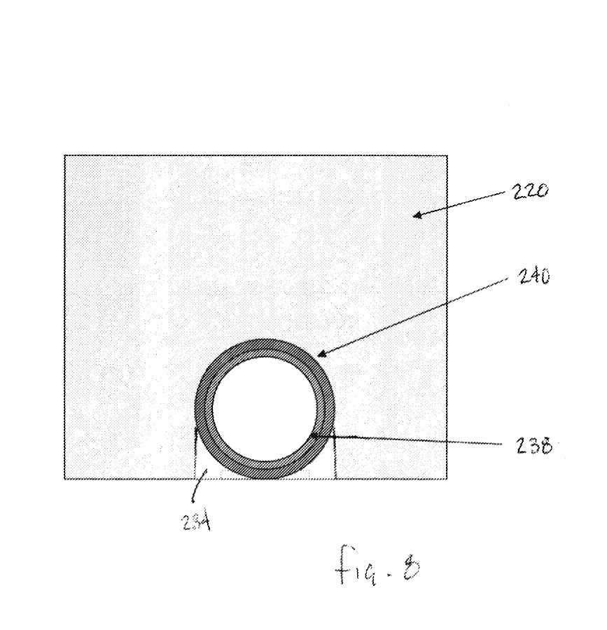

Turning now to FIG. 7, it is known that when piping 138 is installed within a building envelope for the purpose of carrying cold water, condensation becomes an issue. Condensation results from humid water saturated air of a higher temperature coming into contact with the cold surface of the pipe 138 carrying the cold water. To prevent the cold air from contacting the outer surface of the pipe 138, this embodiment of the present invention provides for a minimum layer of insulation 140 to be installed over the cavity 134 in the insulation block 120. In all other respects, the insulation block 120 operates as described above.

The insulation layer 140 is calculated as follows to be minimally 0.25″, which is enough to prevent the formation of condensation on the pipe 138 yet still allow the necessary heat transfer to prevent the pipe 138 from freezing. The minimum thickness is calculated as follows:

=KR(Tdp−Top)/(Tadb−Tdp)

Where K is the thermal conductivity of the material, R is the insulative value of the insulation material, Tdp is the dew point temperature, Top is the operating temperature of the piping, and Tadb is the ambient dry bulb temperature. For normal operating conditions where condensation is likely to occur, we can assume a K of 0.29, an R of 5 per inch, Tdp=60° F. (dew point of 60), Top=55° F. (55° water in the pipe) and a Tadb=90° F. (90° ambient temperature). Accordingly the calculated minimum thickness is:

0.207 inches=(0.29*5)*((60−55)/(95−60))

Adding a factor of safety, for the purpose of the present invention in preventing condensation on a cold water pipe, the minimum thickness is calculated at 0.25″.

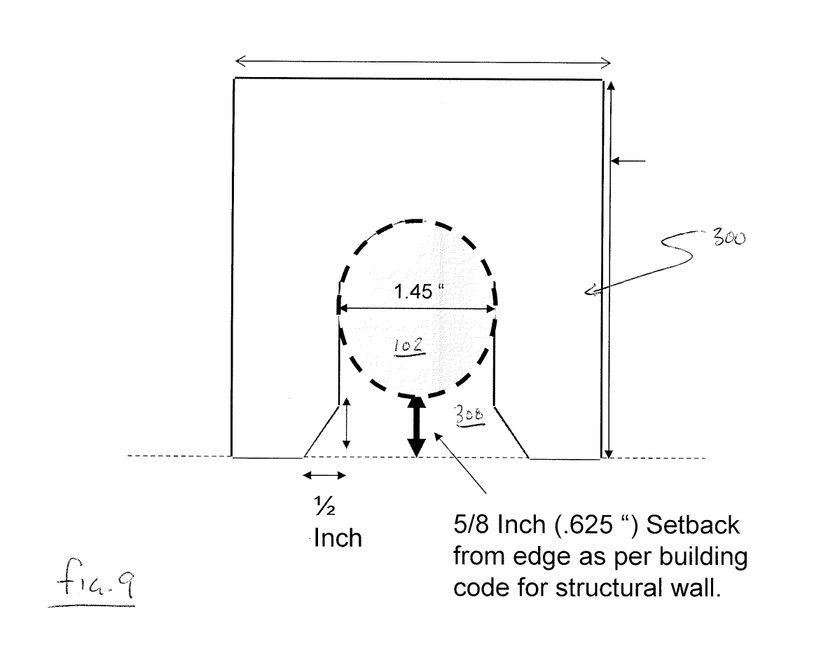

Similarly at FIG. 8, an alternate arrangement for preventing the cold air from contacting the outer surface of the pipe 238 is shown. This embodiment of the present invention provides for a minimum layer of insulation 240 to be wrapped around the outer surface of the piping 238 installed within the cavity 234 in the insulation block 220. In all other respects, the insulation block 220 operates as described above.

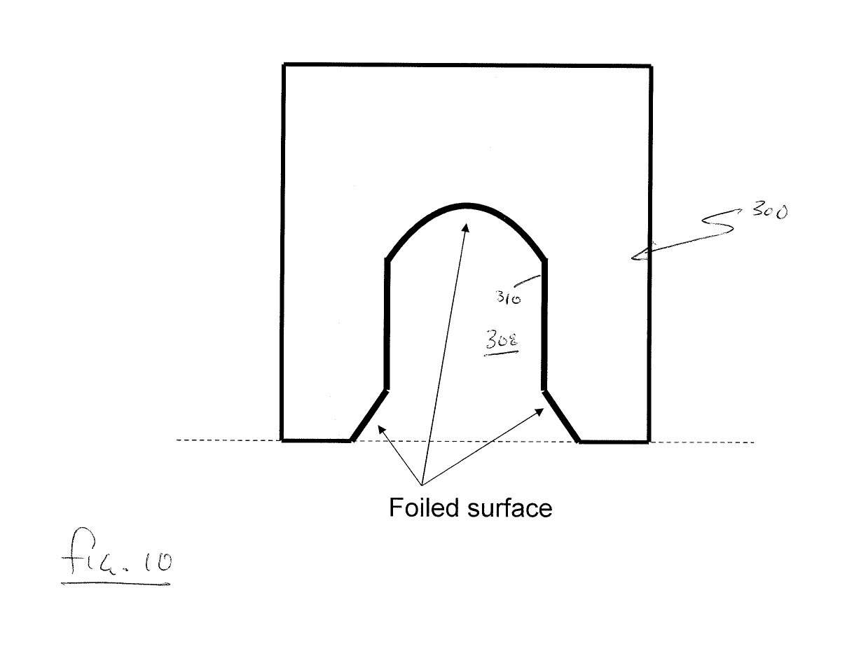

Turning now to FIG. 9 an embodiment provides individual modular insulation blocks 300 fabricated in a geometric shape that encapsulates the pipe 102 in insulation. The entire modular insulation block 300 is inserted behind the pipe 102 and into the space between interior and exterior sheathing such that the insulation block 300 rests against the interior sheathing. By placing a series of these interlocking insulating blocks behind and along a pipe, the piping 102 is encapsulated in a continuous insulating system along its entire length. Further, the insulation blocks 300 include a slot 308 formed therein that allows natural convection heat to pass through the wall sheathing and into the slot 308, allowing it to come into contact with this piping 102.

In operation, the insulation block 300 of the present invention is installed around the pipe 102 and into the wall cavity as was disclosed above. It can also be seen that the pipe 102 is received within the insulation block 300 and is necessarily positioned adjacent the warm side of the cavity. The block includes an opening 308 that extends up to and adjacent the rear surface of the wall sheathing such that the opening 308 facilitates heat transfer through the sheathing and into the opening 308 to prevent freezing of the piping 102 contained therein. More preferably the opening 308 is wider where it is adjacent the sheathing. Still more preferably the opening is wedge shaped so as to focus any heat captured as it passes through the sheathing onto the pipe contained therein. It is also preferable that the slot 308 be configured at a depth to allow the piping to be positioned a minimum of ⅝″ from the sheathing such that such a system can be employed in a structural wall wherein codes prohibit holes in structural elements less than ⅝″ from the edge thereof.

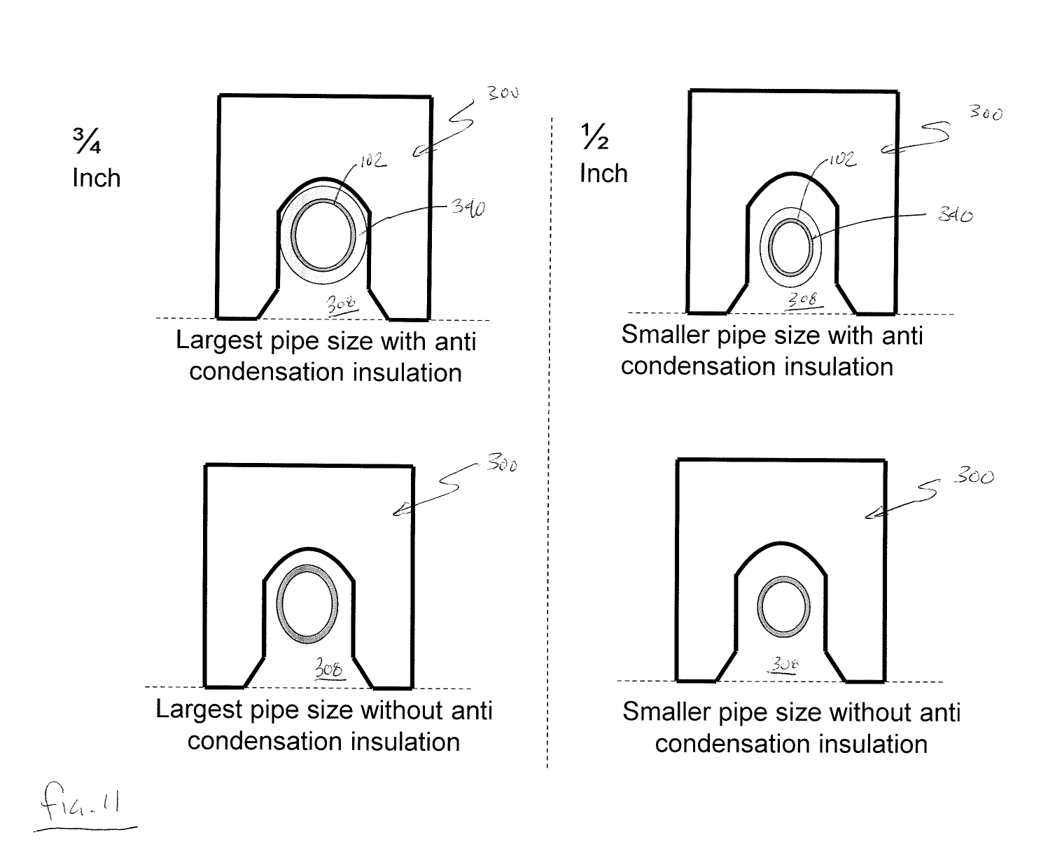

As shown at FIG. 10, the block 300 may also include a continuous thermally conductive layer 310 as described and illustrated previously that covers the interior surface of the cavity and at least a portion of the front surface of the insulation block proximate the slot. Similarly, the thermally conductive layer may extend fully over the front surface of the insulation block 300, although preferably, the thermally conductive surface will end approximately ½ inch from the edge of the front face of the insulation block 300 to prevent cold from being conducted into the pipe 102 at the edge of the contact surface. Preferably, the thermally conductive layer is a metallic layer such as a metallic tape.

Further, at FIG. 11, to prevent the cold air from contacting the outer surface of the pipe 102, this embodiment of the present invention provides for a minimum layer of anti-condensation insulation 340 to be installed as a wrap about the pipe 102. In all other respects, the insulation block 300 operates as described above. The slot 308 is sized such that it can receive the common piping sizes of ½″ and ¾″ with or without the anti-condensation wrap 340.

It can therefore be seen that the present invention provides a method and system for effectively insulating piping located in an exterior wall construction in a manner that protects the piping from freezing. The insulation block reliably provides a thickness of insulation material behind the piping such that the insulation material is positioned between the piping and the exterior wall surface and the insulation maintains the piping in contact with the rear surface of the interior wall sheathing to facilitate heat transfer from the interior of the building and into the piping. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. An insulation system for insulating piping contained in an exterior wall of a structure comprising:
a rigid insulation block having a proximal end, a distal end and front and rear surfaces extending along a length of said insulation block between said proximal and distal ends;
at least one cavity formed in of said insulation block proximate said front surface and extending along the length of said block from said proximal end to said distal end;
a slot extending between said front surface and said at least one cavity said slot having a tapered opening at said front surface; and
an anti-condensation layer of insulation disposed within the slot,
wherein said at least one cavity is configured to receive a pipe therein such that said pipe is substantially fully surrounded by said rigid insulation a portion of said pipe receiving heat through said anti-condensation layer.

2. The insulation system of claim 1, said exterior wall structure having a space formed therein, said space having a warm side and a cold side, said insulation system being received within said space with said rear surface adjacent said cold side and said front surface adjacent said warm side.

3. The insulation system of claim 1, further comprising:
a continuous thermally conductive layer covering an interior surface of said cavity, said slot and at least a portion of said front surface of said block proximate said slot.

4. The insulation system of claim 3, wherein said thermally conductive layer is a metallic layer.

5. The insulation system of claim 1, further comprising:
an anti-condensation layer of insulation disposed about said pipe within the slot,
wherein said at least one cavity is configured to receive a pipe therein such that said pipe is substantially fully surrounded by said rigid insulation a portion of said pipe receiving heat through said anti-condensation layer.

6. The insulation system of claim 5, wherein said anti-condensation layer is a layer of insulation having a thickness of about 0.25″.

7. The insulation system of claim 1, said exterior wall structure having a plurality of spaced apart framing members, said framing members supporting exterior sheathing on one side and interior sheathing on an opposing side, said framing members, interior sheathing and exterior sheathing forming a space therebetween, said space having a warm side adjacent said interior sheathing and a cold side adjacent said exterior sheathing, said insulation system being received within said space with said rear surface adjacent said exterior sheathing and said front surface adjacent said interior sheathing, an anti-condensation layer of insulation disposed about said pipe within the slot, wherein said at least one cavity is configured to receive a pipe therein such that said pipe is substantially fully surrounded by said rigid insulation a portion of said pipe receiving heat through said anti-condensation layer.

8. The insulation system of claim 7, further comprising:
a continuous thermally conductive layer covering an interior surface of said cavity, said slot and at least a portion of said front surface of said block proximate said slot, said thermally conductive layer being in thermal communication with said interior sheathing.

9. The insulation system of claim 8, wherein said thermally conductive layer is a metallic layer.

10. The insulation system of claim 7, wherein said anti-condensation layer is a layer of insulation having a thickness of about 0.25″.
